(19) United States
(12) Patent Application Publication
(10) Pub. No.: US 2026/0209875 A1
(43) Pub. Date: Jul. 23, 2026

(54) GRANULE AND/OR POWDER SOLID MATERIALS INJECTION LANCE FOR INJECTING SOLID MATERIALS IN THE FORM OF GRANULES AND/OR POWDERS INTO A METALLURGICAL FURNACE

(71) Applicant: TENOVA S.P.A., Milano(IT) (IT)

(72) Inventors: Mattia Bissoli, Bovolone (VR) (IT); Mauro Gizzi, Ossona (MI) (IT); Enrico Malfa, Zanica (BG) (IT)

(21) Appl. No.: 19/142,619

(22) PCT Filed: Dec. 20, 2023
(86) PCT No.: PCT/IB2023/063003

§ 371 Date: Jun. 23, 2025

(30) Foreign Application Priority Data
Dec. 23, 2022 (IT) 102022000026757

(51) Int. Cl. C21C 7/00

(52) U.S. Cl. CPC C21C 7/0037

(57) ABSTRACT

A lance for a metallurgical furnace includes a tubular housing along which a plurality of longitudinal segments follow one another, including a feeding segment of solid materials, a transporting segment and an outflow segment including an outflow opening at the proximal end; a plurality of distinct tubular ducts arranged inside the housing, each extending between first and second ends along a portion of the feeding segment, having a first input mouth, and along a portion of the transporting segment ending in an output mouth in fluid communication with the outflow opening, the longitudinal development axes of the tubular ducts are non-coincident and parallel to the central longitudinal axis; and a feeding manifold for each tubular duct associated with the housing at the feeding segment in fluid communication with the first input mouth of the respective tubular duct including a connecting junction with a feeding source of the flow of solid materials.

The present invention refers to a granule and/or powder solid materials injection lance for injecting solid materials in the form of granules and/or powders into a metallurgical furnace.

In the electric arc (EAF) furnaces iron and steel field, it is known injecting into the metal bath various typologies of fossil origin carbon, such as coal, coke, petroleum coke, methane, which can be introduced in various forms:
solids in lumps (>5 cm) introduced as a charging material together with the scrap in the charging basket or in other charging systems, for example in the horizontal continuous charging systems;
granulated solids (<3 mm) injected through one or more lances, for example a movable lance positioned through the slagging door of the furnace and/or one or more fixed lances mounted through the side walls of the furnace;
gas (methane) injected through ore or more oxygen burners mounted through the side walls of the furnace and also acting as heat sources for the metal bath.

In particular, using systems for injecting solid materials installed at the walls of the EAF furnaces is known and their efficiency is crucial for optimizing the iron and steel process.

The carbon injected in the form of solid material in the form of granules and/or powders, in combination with the oxygen injected into the furnace and/or with the oxides (for example iron oxides) present in the metal slag, generates carbon oxide, which allows to generate gaseous bubbles which increase the volume of the slag, creating a foam on the surface of the liquid metal. This foam allows to screen the electric arc generated by the electrodes, reducing the thermal losses by irradiation and increasing the overall efficiency of the process.

The design of the injection systems and the strategy for injecting solid materials represent a crucial aspect for conducting the process, as well as the distribution of the injected solid material at the interface slag-liquid bath.

Indeed, the solid material injection needs to involve the widest possible area with the aim of maximizing the interaction of the solid material with the iron oxide so as to allow its reduction and maximize the conversion yield of the process.

Furthermore, the penetration of the solid material into the metal bath needs to be controlled in order to obtain the desired percentage of carbon in the metal bath.

For the processes of “foaming” the slag and reducing the oxides, in particular, the penetration of the solid material is optimal when it reaches the separation surface between the liquid metal bath and the slag layer. Lastly, the system for injecting solid materials needs to minimize the risk that the injected solid material is dragged inside the furnace and the flue gas system without penetrating into the slag and into the metal bath, resulting in a reduction of the injection efficiency. This latter phenomenon is related in particular to the very fine and lightweight materials (for example lime) which have greater probability not to reach the metal bath and to be dragged by the sucked flue gases stream.

The injection systems installed at the walls of the known EAF furnaces can be of different typologies:
“Single injector” systems. Such a system consists of a single tube inside which the solid material in the form of granules and/or powders is transported by a carrier or transporting gas (usually air). This system is commonly used but has a limit related to the injection speeds (generally <100 m/s), and consequently to the injection efficiency, due to both the required air amounts and erosion problems caused by the nature of the solid material itself.
“Coupled” injection systems, wherein the “single injector” system for the solid material is coupled with a second system for injecting a process gas (usually oxygen) high speed jet, generally a supersonic jet. This solution allows to overcome the above-mentioned limits of the “single injector” systems, being the solid material dragged and accelerated by the process gas high speed jet. The coupling between the two systems usually occurs in a single device (referred to in the industry jargon as “injection point”) installed on the side wall of the furnace and which in turn can be made in different forms: with “concentric tubes” or with “parallel tubes”.

In “concentric tube” devices, in fact, there are at least two tubes concentric to each other, wherein the solid material is usually fed through the inner tube and a gas is fed through the outer tube. These devices are efficient in terms of injection into the metal bath, but have a limited capacity of distributing the solid material on the liquid bath and, in case of highly volatile solid material, promote the generation of high temperature concentrated zones (hot spots) which reduce the capabilities of forming foaming slag.

An example of a “concentric tube” device is described in U.S. Pat. No. 6,558,614.

In the “parallel tube” devices there are at least two tubes, i.e., two lances, arranged substantially parallel to each other, one of which, generally that for injecting high speed gas (oxygen supersonic jet), is arranged at a higher level than the other, generally that for injecting solid material. This solution is based on the idea of promoting the injection of the solid material by increasing its speed by dragging due to the proximity to an oxygen supersonic jet and keeping the possibility of distributing the material itself in the slag and at the liquid-slag interface. The gas (oxygen) supersonic jet generated by the upper lance, indeed, has the role of both penetrating the slag and transporting the solid material injected by the lower lance. The latter can operate at speeds required only to pneumatically transport the solid material to the meeting point with the gas supersonic jet.

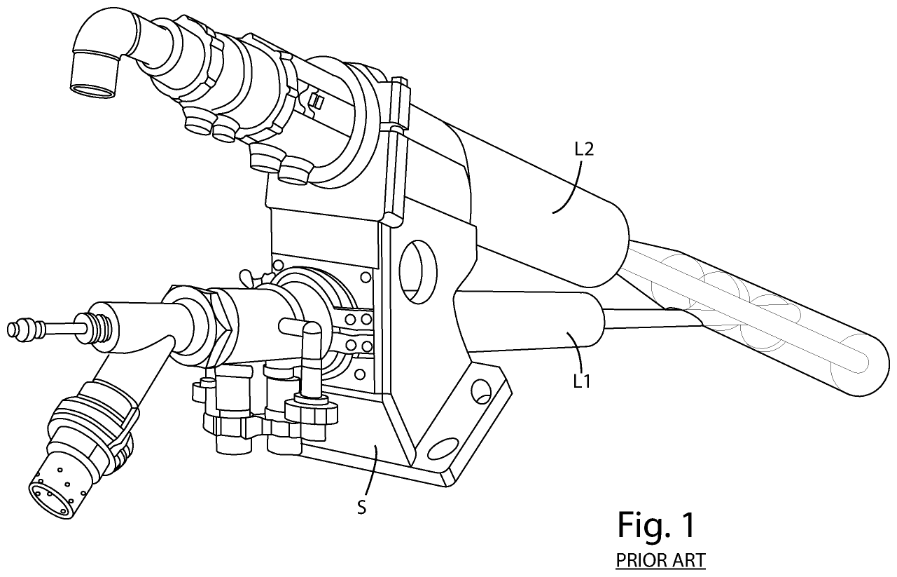

An example of a “parallel tube” device is shown in FIG. 1 which shows a supporting structure S fixable outside the side walls of a furnace and having two mounting cradles arranged on top of each other, wherein a first lance L1 for injecting solid material is mounted in the lower cradle and a second lance L2 for injecting an oxygen supersonic jet is mounted in the upper cradle. Such a device forms a so-called “injection point” of a furnace.

The known solutions described above have the limit of injecting, in each moment, a single type of solid material for each “injection point” (in jargon, as mentioned above, “injection point” is intended as a single injector of solid material, possibly coupled with a supersonic oxygen injector).

This limit is particularly apparent when the physical-chemical features of the solid materials to be injected are different. For example, a different density or granulometry involves different transporting speeds not obtainable in a single injection tube. Different chemical-physical features (such as for example softening point, chemical affinity) can result in problems of obstruction of the injection tube.

If, for process requirements, there is a need to inject multiple solid materials from the same position, therefore, installing multiple lances next to each other, each dedicated to a specific solid, and in proximity to a single supersonic lance is a common practice. Such a solution involves:
Greater construction complexity, being it required to multiply the systems for fixing the lances outside the side walls of the furnace and modify the cooled panels which equip the side walls of the furnace for allowing the various lances to be installed.
Greater thermal losses, being it required to provide a cooling system for each lance.
Reduction of the injection efficiency. In presence of several solid material injection lances cooperating with a single supersonic oxygen injection lance, not all the solid material injection lances can be optimally positioned with respect to the supersonic oxygen injection lance, with the possible resulting efficiency loss. For example, the flow of the solid material injected by one of the lances could not optimally reach, or not reach at all, the supersonic jet, being capable of insufficiently penetrating into the slag layer or dispersing into the furnace due to the flue gas sucking currents.
Reduction of the process efficiency. Indeed, it is difficult to manage advanced configurations for locally injecting and mixing the different solid materials useful for example to control the temperature and to optimize the formation of the foam. Indeed, different carbon materials correspond to different chemical-physical

reactivities inside the slag, generating in some cases (for example in the case of materials with high fraction of volatile compounds, such as polymeric materials—plastic, rubber—or biochar) concentrated temperature increases (hot spot) and consequent slag liquefaction and fluidification. In order to mitigate such localized heating effect, it may be necessary to simultaneously inject solid materials with high melting points (such as for example lime, slag granules, metal oxides which undergoes a reduction in the slag itself also deriving from production residuals such as scale, powders recovered from the filters, etc.).

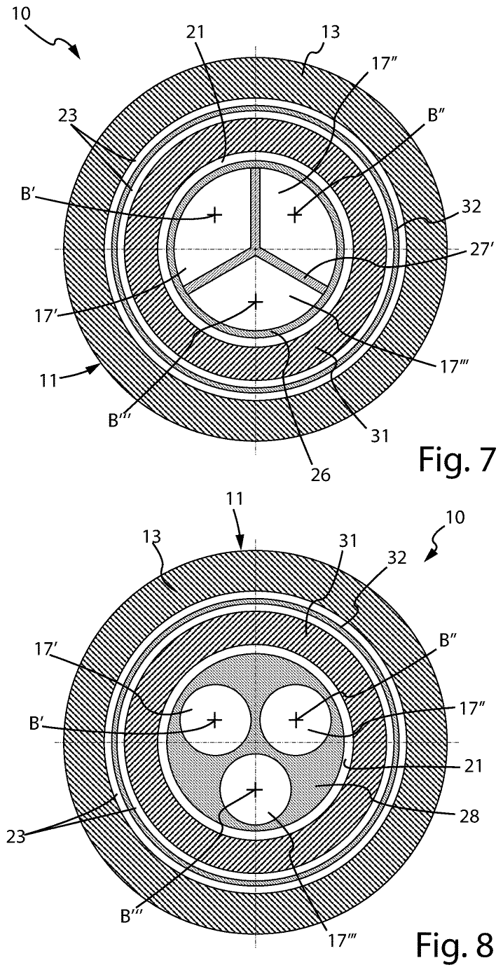

The above-mentioned patent U.S. Pat. No. 6,558,614 provides to inject solid materials through multiple concentric annular gaps (FIG. 7 of U.S. Pat. No. 6,558,614). This solution involves a high longitudinal bulk of the injector due to the offset arrangement of the fittings for feeding the solid materials to the gradually further inner annular gaps. Furthermore, in order to obtain, where required, an equivalent passage section between the various annular gaps, the outermost ones should have a gradually lower thickness upon increasing the distance from the central axis of the injector, consequently having generally different behaviours of the flows of solid materials fed through the different annular gaps.

Furthermore, as mentioned above, a device as that known from U.S. Pat. No. 6,558,614, wherein the same injector allows to inject solid materials together with a dragging supersonic jet, does not allow to modify the relative positions (distance and/or angle) between the directions of the two jets (flow of solid material and supersonic flow of dragging gas), resulting in a lower operative flexibility.

Therefore, there is the need to have a granule and/or powder solid materials injection lance which is compact and space-saving and which allows to inject various typologies of solid materials, reducing the number of “injection points” a metallurgical furnace can be provided with.

Another object of the present invention is to provide an injection lance that allows to optimize the injection efficiency also upon varying the typology of injected solid material.

Another object of the present invention is to provide an injection lance that can be easily installed also in existing metallurgical furnaces replacing the known devices with a limited number of interventions, thus allowing the same to be modernized.

Another object of the present invention is to provide a particularly easy, functional and low costs granule and/or powder solid materials injection lance for injecting solid materials in the form of granules and/or powders into a metallurgical furnace.

These objects according to the present invention are achieved by making a granule and/or powder solid materials injection lance for injecting solid materials in the form of granules and/or powders into a metallurgical furnace as set forth in claims 1.

Further features are provided in the dependent claims.

The features and advantages of a granule and/or powder solid materials injection lance for injecting solid materials in the form of granules and/or powders into a metallurgical furnace according to the present invention will be more apparent from the following exemplary and non-limiting description referred to the attached schematic drawings wherein:

FIG. 1 is an axonometry view of a “parallel tube” device for injecting solid materials in the form of granules and/or powders according to the prior art;

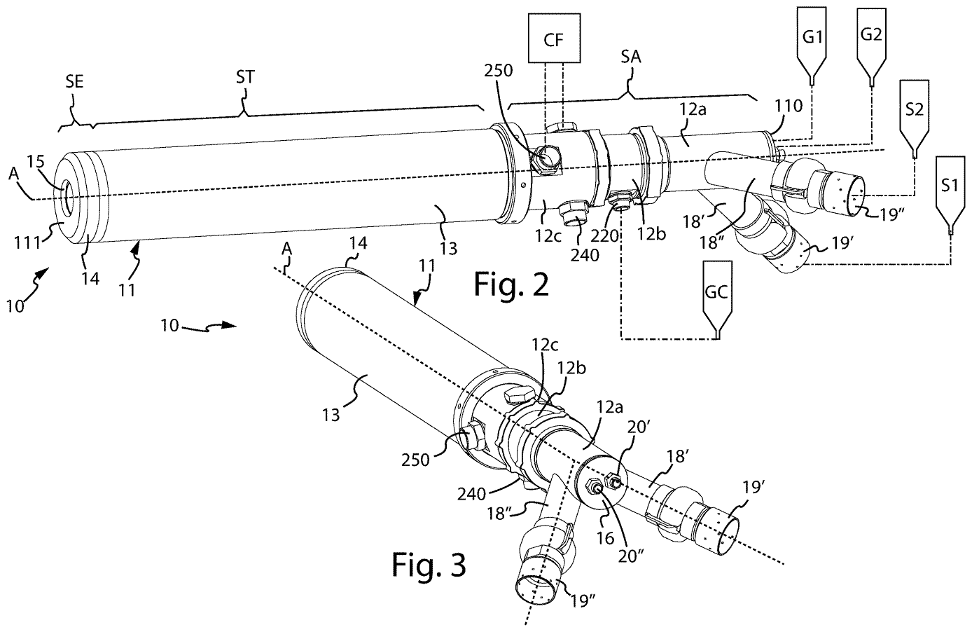

FIGS. 2 and 3 show in axonometry according to different angles a possible embodiment of a granule and/or powder solid materials injection lance according to the present invention;

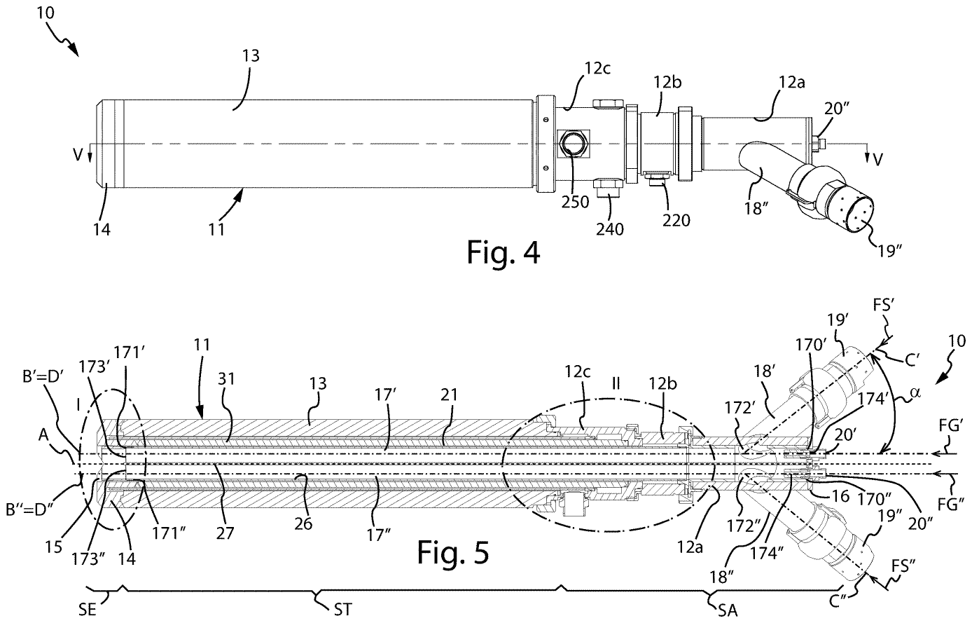

FIG. 4 is a side elevation view of the lance of FIGS. 2 and 3;

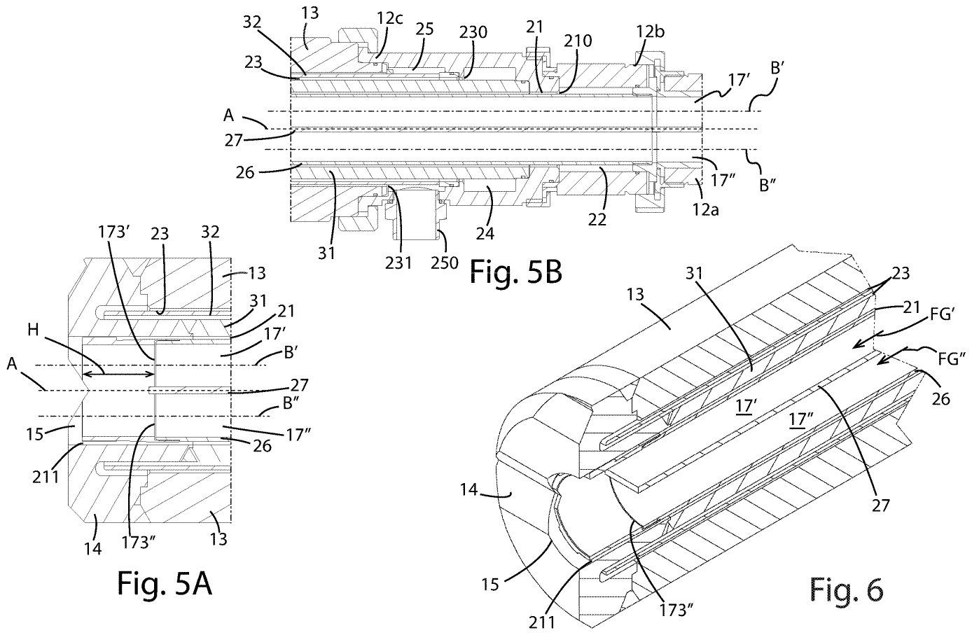

FIG. 5 is a section according to the plane V-V of FIG. 4;

FIGS. 5A and 5B show on an enlarged scale the details I and II of FIG. 5;

FIG. 6 shows on an enlarged scale and longitudinal cross section a portion of the lance of FIGS. 2 to 5;

FIGS. 7, 8, 9 and 9A show, in cross section taken at the transporting segment of the housing, possible alternative embodiments of the lance according to the present invention;

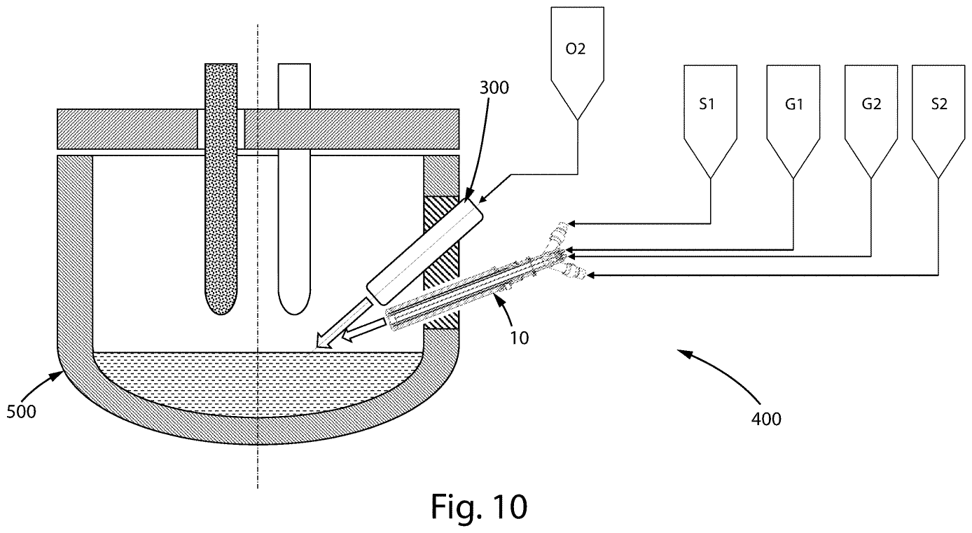

FIG. 10 shows a system for injecting solid and gaseous materials into an electric arc furnace comprising a lance according to the present invention;

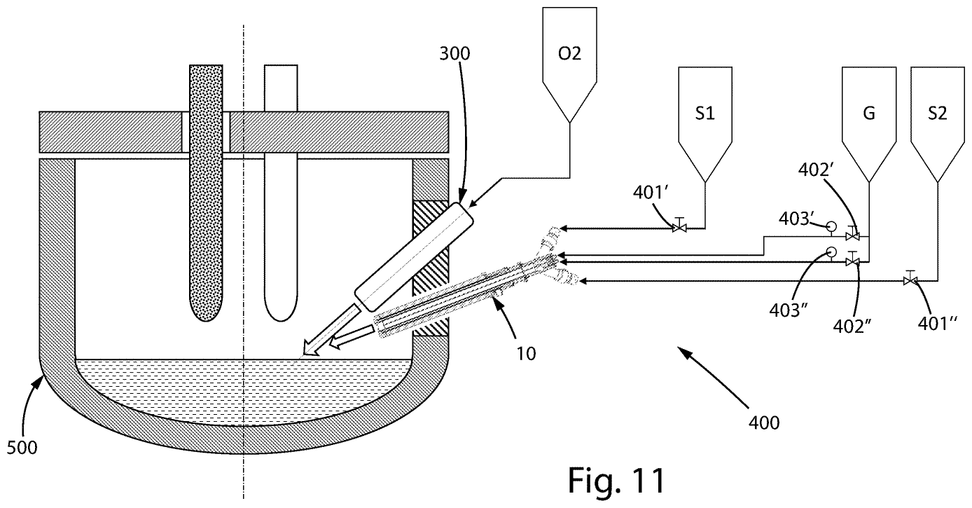

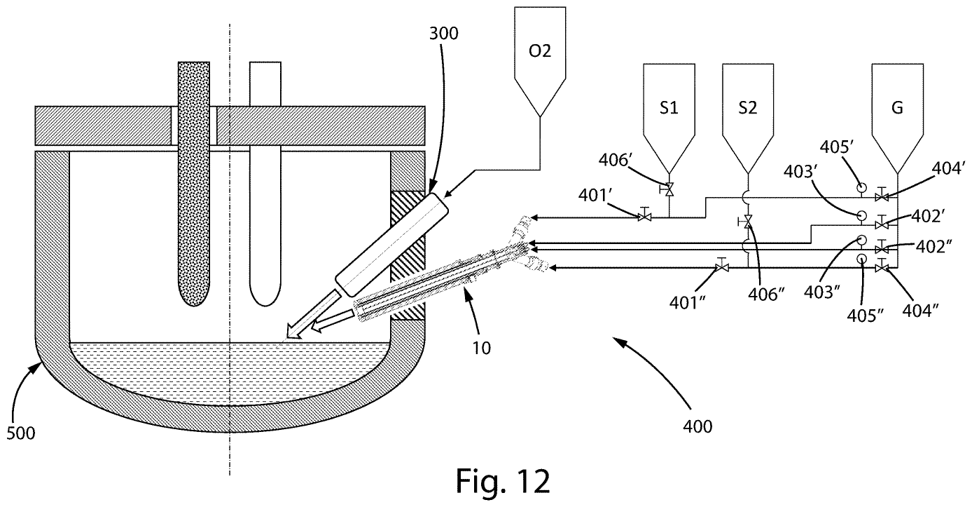

FIGS. 11 and 12 show alternative configurations of a system for injecting solid and gaseous materials into an electric arc furnace comprising a lance according to the present invention.

With reference to the attached figures, a lance 10 for injecting solid materials in the form of granules and/or powders for injecting solid materials in the form of granules and/or powders into a metallurgical furnace is shown.

The solid materials are functional to the conduction of the metallurgical process conducted in the furnace. With specific reference to processes for producing steel conducted in electric arc furnaces (EAF), the solid materials are, for example, materials containing carbon—including coal, coke, petroleum coke, lime, polymeric materials (plastics, rubbers), biochar—or slag granules, metal oxides also deriving from production residuals such as scales or powders recovered from the filters for purifying the flue gases, useful to form the slag, to the reduction processes, to the composition and alloying of the steel.

The solid materials are in the form of granules (<3 mm) or powders.

The solid materials are fed to the lance 10 in mixture with a carrier or transporting fluid, generally a carrier gas, generally air or oxygen or inert gases such as nitrogen or argon.

In the following of the description, reference will be made to a flow of solid materials or simply to fed and transported solid materials, being it intended to indicate a mixture of solid materials in the form of granules and/or powders and of a carrier or transporting fluid.

The lance 10 comprises a tubular housing 11 having a central longitudinal axis A and extending between a distal end 110 and a proximal end 111 axially opposite to each other.

A cavity internal to the lance 10 and extending from the distal end 110 to the proximal end 111 thereof is defined inside the housing 11.

Along the housing 11, starting from its distal end 110 towards its proximal end 111, a plurality of longitudinal segments follow one another:
a feeding segment SA of solid materials in the form of granules and/or powders, i.e., of mixtures of solid materials and of a transporting fluid, generally a gas such as for example air,
a transporting segment ST of the fed solid materials and
an outflow segment SE of the transported solid materials comprising an outflow opening 15 at the proximal end 111.

The housing 11 consists of one or more, generally cylindrical, tubular bodies defining or forming the different feeding SA, transporting ST, and outflow SE segments.

In the embodiment shown in the attached figures, the housing 11 consists of a plurality of generally cylindrical tubular bodies being open at the opposite ends and arranged coaxial to each other and assembled to each other, advantageously in a removable manner, respectively:
a plurality of first tubular bodies 12a, 12b, 12c forming the feeding segment SA, respectively a first end tubular body 12a, a first middle tubular body 12b and a first junction tubular body 12c;
a second tubular body 13 forming the transporting segment ST;
a third tubular body 14 forming the outflow segment SE.

The distal end 110 is generally closed; in the depicted case, the distal end 110 is closed by a bottom wall 16 fixed to the corresponding end of the first end tubular body 12a.

The proximal end 111 is generally open, the outflow opening 15 being defined therein.

As will be more apparent below, the first tubular bodies 12a, 12b, 12c which follow one another in sequence starting from the distal end 110 towards the proximal end 111 have a gradually increasing cross section and feeding manifolds and/or connecting junctions and fittings for feeding not only the flows of solid materials, but, optionally and advantageously, also other process (transporting gases and/or containing gases) and/or functional (cooling fluids) fluids are formed at each of them.

The lance 10 is adapted to be installed into a metallurgical furnace, in particular an also already existing electric arc furnace. The lance 10 is generally arranged through the side wall of the furnace, on which it is mounted through suitable supports, which can possibly allow relative movements between the lance 10 and the wall of the furnace, as known to those skilled in the art.

In use, the feeding segment SA, i.e., the first tubular bodies 12a, 12b, 12c forming it, is intended to be arranged outside the furnace, while the outflow segment SE, i. e. the third tubular body 14, is intended to be arranged inside the furnace with the outflow opening 15 facing the metal bath. The transporting segment ST, i.e., the second tubular body 13, in use is intended to be arranged through a corresponding opening formed in the side walls of the furnace prolonging by a tract inside the furnace and by a tract outside the furnace, where the supports of the lance 10 are arranged.

The end 110 of the housing 11 is defined as “distal” as being, in use, distant from the metal bath and external to the furnace.

The end 111 of the housing 11 is defined as “proximal” as being, in use, proximate to the metal bath and internal to the furnace.

According to the present invention, the lance 10 comprises at least two and, therefore, a plurality of tubular ducts 17′, 17″ which are separated and distinct from each other and which are arranged or however formed or defined inside the housing 11, wherein each of said tubular ducts 17′, 17″ has a respective longitudinal development axis B′, B″ parallel and non-coincident with the central longitudinal axis A and is coupled to at least one respective feeding manifold 18′, 18″ of a corresponding flow of solid materials FS′, FS″.

Each tubular duct 17′, 17″ longitudinally extends between a first end 170′, 170″ and a second end 171′, 171″, which are axially opposite to each other and respectively facing the distal end 110 and the proximal end 111.

Each tubular duct 17′, 17″ longitudinally extends:
along at least one portion of the feeding segment SA, at which it has at least one first input mouth 172′, 172″ of a respective flow of solid materials FS′, FS″ in the form of granules and/or powders, and
along at least one portion of the transporting segment ST ending in an output mouth 173′, 173″ of the respective flow of solid materials which is in fluid communication with the outflow opening 15.

The lance 10 further comprises at least one feeding manifold 18′, 18″ for each one of the tubular ducts 17′, 17″. Each tubular duct 17′, 17″ is connected to at least one respective feeding manifold 18′, 18″ that compete with it exclusively and which, therefore, is separated and distinct from the feeding manifolds 18′, 18″ that are connected to the remaining tubular ducts 17′, 17″ for feeding into them a respective flow of solid materials.

Each feeding manifold 18′, 18″ is associated with the housing 11 at the feeding segment SA and is in fluid communication with the first input mouth 172′, 172″ of the respective tubular duct 17′, 17″.

Each one feeding manifold 18′, 18″ is provided with at least one connecting junction 19′, 19″ adapted to be coupled to a respective feeding source S1, S2 . . . Sn of the respective flow of solid materials FS′, FS″ (mixture of a transporting gas and of solid materials in the form of granules and/or powders).

The tubular ducts 17′, 17″, as mentioned above, are arranged, or however formed or defined in the housing 11. As also detailed below, they can be made in a plurality of different manners, alternative and non-limiting to each other. Thereby, for example, their structure can be non-uniform along their length being formed or defined for a tract of their length by a tubular or cylindrical body, or by a portion thereof, arranged inside the housing 11 and/or for another tract of their length by a portion of the same housing 11, i.e., by a portion of the first tubular bodies 12a, 12b, 12c and/or of the second tubular body 13 and/or of the third tubular body 14, with interposition of junctions and/or gaskets adapted to ensure the continuity thereof. Furthermore, the tubular ducts 17′, 17″ can have a circular, polygonal, or mixed cross section, also different from each other in the shape and/or size.

As already mentioned above and as shown in the attached figures, the longitudinal development axes B′, B″ of the tubular ducts 17′, 17″ are parallel and non-coincident with each other; furthermore, they are parallel and, preferably, non-coincident with the central longitudinal axis A of the housing 11 i.e., of the lance 10.

In a plane orthogonal to the central longitudinal axis A, the longitudinal development axes B′, B″ of the tubular ducts 17′, 17″ are for example arranged spaced apart from each other along a circumference concentric to the central longitudinal axis A.

The longitudinal development axes B′, B″ of the tubular ducts 17′, 17″ are not necessarily symmetry axes.

The tubular ducts 17′, 17″ divide the cavity internal to the housing 11, i.e., to the lance 10, in a corresponding plurality of longitudinal chambers separated and distinct from each other, each of which can be travelled by a respective flow of solid materials FS′, FS″ fed therein by a respective feeding manifold 18′, 18″ separated and distinct from the feeding manifolds 18′, 18″ which are coupled to the remaining tubular ducts 17′, 17″. The tubular ducts 17′, 17″, i.e., the longitudinal chambers defined thereby, are equal in number to the feeding manifolds 18′, 18″ with the respective connecting junctions 19′, 19″; each tubular duct 17′, 17″ is connected to a respective feeding manifold 18′, 18″ with a respective connecting junction 19′, 19″, according to a one-to-one correspondence.

Therefore, flows of solid materials equal to or different from each other, for example in the typology of solid material and / or in the typology of transporting fluid and/or in the features of the feeding flow (flow rate, speed, temperature, pressure, etc.) can be fed by the same single lance 10, simultaneously or in deferred times.

Thereby, each tubular duct 17′, 17″, i.e., each longitudinal chamber in which the cavity internal to the lance 10 is divided, is travelled by its own flow of solid materials optimized as a function of the chemical-physical features of a determined solid material or “family” of similar solid materials. Providing for each one of the tubular ducts 17′, 17″ a respective feeding manifold 18′, 18″ separated from and independent of the others allows to generate flows of solid materials FS′, FS″ having different fluid dynamic features (for flow rate, speed, temperature, pressure, etc.) optimized for transporting a different solid material. Therefore, two or more different solid materials can be injected by the same lance 10 and, therefore, making a single “injection point” in the furnace. Injecting the two or more solid materials, or generally activating the two (or more) flows of solid materials, can occur simultaneously or in deferred times, depending on the process requirements.

In a possible embodiment, as shown in the attached figures, the first input mouth 172′, 172″ is formed at the side wall which delimits the respective tubular duct 17′, 17″ and develops along a direction C′, C″ incident to the longitudinal development axis B′, B″ of the respective tubular duct 17′, 17″ forming a non-zero angle a with it so as to direct the flow of solid material injected through it towards the output mouth 173′, 173″. The angle a is different from 90° and 180°.

In a possible alternative embodiment, not shown in the attached figures, the first input mouth 172′, 172″ is formed at the first end 170′, 170″ of the respective tubular duct 17′, 17″ and develops along a direction C′, C″ parallel or coincident with the respective longitudinal development axis B′, B″.

Each feeding manifold 18′, 18″ consists of a tubular element coaxial to the respective first input mouth 172′, 172″.

Optionally, at least one or, preferably, each one of the tubular ducts 17′, 17″ comprises at least one second input mouth 174′, 174″ of an auxiliary gaseous flow FG′, FG″ which is defined along the longitudinal portion of the tubular duct 17′, 17″ extending along the feeding segment SA and which is in fluid communication with a respective connecting fitting 20′, 20″ adapted to be coupled to a feeding source G1, G2 . . . Gn of an auxiliary gaseous flow.

Preferably, as shown in the attached figures, the second input mouth 174′, 174″ is formed at the first end 170′, 170″ of the respective tubular duct 17′, 17″ and develops along a direction D′, D″ parallel or coincident with the longitudinal development axis B′, B″ of the respective tubular duct 17′, 17″.

According to an alternative embodiment, not shown, the second input mouth 174′, 174″ is obtained at the side wall which delimits the respective tubular duct 17′, 17″ and develops along a direction D′, D″ incident to the longitudinal development axis B′, B″ of the respective tubular duct 17′, 17″ forming with it a non-zero angle different from 90° or 180°.

If, as shown in the attached figures, the first input mouths 172′, 172″ with the respective feeding manifolds 18′, 18″ are formed at the side walls which delimit the respective tubular ducts 17′, 17″ along development directions C′, C″ incident to the respective longitudinal development axis B′, B″, the second input mouths 174′, 174″ are preferably formed at the first end 170′, 170″ of the respective tubular duct 17′, 17″ and develop along a direction D′, D″ parallel or coincident with the longitudinal development axis B′, B″ of the respective tubular duct 17′, 17″. In the shown embodiment, the second input mouths 174′, 174″ are formed at the bottom wall 16.

If, instead, the first input mouths 172′, 172″ with the respective feeding manifolds 18′, 18″ are formed at the first end 170′, 170″ of the respective tubular ducts 17′, 17″ along development directions C′, C″ parallel or coincident with the respective longitudinal development axis B′, B″, the second input mouths 174′, 174″ are preferably formed at the side wall which delimits the respective tubular duct 17′, 17″ and develop along a direction D′, D″ incident to the longitudinal development axis B′, B″ of the respective tubular duct 17′, 17″.

The auxiliary gaseous flows FG′, FG″ injected through the second input mouths 174′, 174″ generally have high speed (for example supersonic speeds) and have the aim to accelerate the respective flows of solid material FS′, FS″ injected through the first input mouths 172′, 172″ and possibly to assist in aligning them parallel to the central longitudinal axis A. The auxiliary gaseous flows FG′, FG″ can consist of air, nitrogen, oxygen, argon, or other gases known in the art.

Between the output mouth 173′, 173″ of each one of the tubular ducts 17′, 17″ and the outflow opening 15 of the housing 11 there is a distance H (FIG. 5A) between 0% and 90%, preferably between 0% and 50%, even more preferably between 0% and 30%, of the overall length of at least the transporting segment ST and the outflow segment SE or between 0% and 90%, preferably between 0% and 50%, even more preferably between 0% and 30%, of the overall length of the transporting segment ST, of the outflow segment SE and of the feeding segment SA downstream of the first input mouths 172′, 172″.

That is, the output mouth 173′, 173″ of each one of the tubular ducts 17′, 17″ is at the outflow opening 15 or is backward with respect to it by a distance H, as defined above.

Optionally, the lance 10 further comprises:
at least one containing gap 21 adapted to be crossed by a containing gaseous flow which externally surrounds the tubular ducts 17′, 17″, singularly or as a whole, and longitudinally extending along at least one portion of the feeding segment SA, at which it has at least one input opening 210 of a containing gaseous flow, and along at least one portion of the transporting segment ST ending in an output opening 211 of the containing gaseous flow which is in fluid communication with the outflow opening 15, and
at least one feeding manifold 22 associated or defined or however formed in the housing 11 at the feeding segment SA and in fluid communication with the input opening 210 of the containing gap 21 and provided with at least one respective connecting fitting 220 adapted to be coupled to a feeding source GC of a respective containing gaseous flow.

Containing gaseous flow (in jargon “shrouding” gaseous flow) is intended to indicate a gaseous flow for example of air, oxygen, methane, hydrogen, or mixtures thereof to form:
a rim for containing the flows of solid materials exiting the lance 10, and
a low density combustion zone,
   both aimed at increasing the maintenance of the speed of the jet of flows of solid materials.

Preferably, the containing gap 21 can have in a section orthogonal to the central longitudinal axis A the shape of an annular rim, preferably of a circular rim, which externally surrounds the assembly of the tubular ducts 17′, 17″.

In a possible embodiment, the lance 10 comprises at least a first pair of tubular walls, preferably cylindrical, arranged inside the housing 11 and coaxial to the central longitudinal axis A and forming therebetween the containing gap 21 which externally surrounds the assembly of the tubular ducts 17′, 17″. As will be more apparent below, the tubular walls of this first pair of tubular walls or however the walls which delimit the containing gap 21 can be formed by walls of distinct components or by walls of components forming other elements of the lance 10, including in particular those components which delimit or form at least partially the side walls of the tubular ducts themselves 17′, 17″ or which surround them.

Optionally, the lance 10 comprises:
at least one cooling gap 23 which externally surrounds the assembly of the tubular ducts 17′, 17″ and which forms or houses a cooling circuit and which longitudinally extends along at least one portion of the feeding segment SA, at which the cooling circuit has at least one input opening 230 and at least one output opening 231 of a cooling fluid flow, and along at least one portion of the transporting segment ST, and -at least one input manifold 24 and at least one output manifold 25 associated or defined or however formed in the housing 11 at the feeding segment SA and in fluid communication respectively with the input opening 230 and with the output opening 231 of the cooling circuit and each of which is provided with at least one respective connecting fitting 240, 250 respectively adapted to be coupled to a feeding source of the cooling fluid and to a discharge of the cooling fluid or connected to an outer circuit CF in which the cooling fluid flows and only schematically depicted.

Preferably, the cooling gap 23 can have in a section orthogonal to the central longitudinal axis A the shape of an annular rim, preferably of a circular rim, which externally surrounds the assembly of the tubular ducts 17′, 17″, internally divided in two circular rims of which the innermost one defines the outward path of the cooling fluid and the outermost one defines the return path of the cooling fluid.

In a preferred embodiment, the lance 10 comprises at least a second pair of tubular walls arranged inside the housing 11 and coaxial to the central longitudinal axis A and forming therebetween the cooling gap 23 which externally surrounds the assembly of the tubular ducts 17′, 17″.

As will be more apparent below, the tubular walls of this second pair of tubular walls or however the walls which delimit the cooling gap 23 can be formed by walls of distinct components or by walls of components forming other elements of the lance 10, including in particular those components which delimit or at least partially form the walls of the tubular ducts 17′, 17″ themselves or which form the housing 11 or which form the walls of the first pair of tubular walls delimiting the containing gap 21, if provided.

In the latter case, advantageously, the cooling gap 23 externally surrounds the containing gap 21.

The cooling fluid can be for example water.

The tubular ducts 17′, 17″ can be made, at least for a portion of their length and, in particular, for the portion of their length extending along the transporting segment ST and along the outflow segment SE and for the tract of the feeding segment SA downstream of the respective first input mouths 172′, 172″, in various manners:
as for example shown in FIGS. 5, 6 and 7, each one of the tubular ducts 17′, 17″ consists of a respective sector of a hollow cylindrical body 26 arranged inside the housing 11 and coaxial to the central longitudinal axis A, wherein each of such sectors is delimited by a portion of the side wall of the hollow cylindrical body 26 and by at least one longitudinal dividing wall 27 internal to it. The dividing wall 27 is fixed to the inner side surface of the hollow cylindrical body 26 and is shaped to divide the internal volume thereof in a plurality of longitudinal chambers each forming one respective tubular duct 17′, 17″. In FIGS. 5 and 6, there is a plane dividing wall 27 which divides the volume internal to the hollow cylindrical body 26 in two sectors forming two respective tubular ducts 17′, 17″. As can be noted from FIG. 5, at the feeding segment SA the dividing wall 27 is prolonged outside the hollow cylindrical body 26 joining with the bottom wall 16. The embodiment shown in FIG. 7 differs from that shown in FIGS. 5 and 6 due to the fact that the dividing wall 27′has three radial planes which divide the volume internal to the hollow cylindrical body 26 in three sectors which, in a cross section, have the shape of a circle sector and which form three tubular ducts 17′, 17″, 17′″. The hollow cylindrical body 26 can consist of a single body or of multiple bodies jointed to each other.

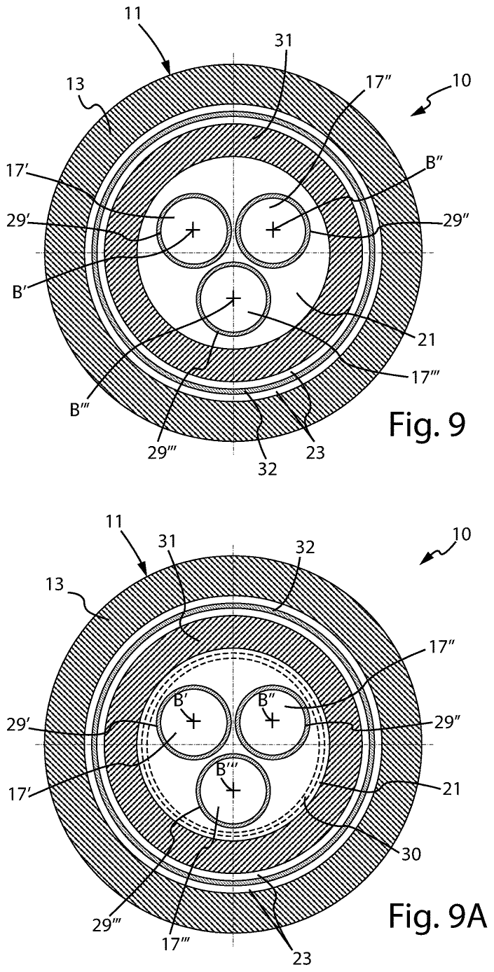

As for example shown in FIG. 8, each one of the tubular ducts 17′, 17″, 17′″ consists of a respective longitudinal hole formed in a solid cylindrical body 28.
As for example shown in FIG. 9, each one of the tubular ducts 17′, 17′ , 17′″ consists of a respective hollow cylindrical body 29′, 29″, 29′″ which, in an alternative schematized embodiment in FIG. 9A, can be housed in turn in a further outer hollow cylindrical body 30.

In any case, one respective feeding manifold separated from and independent of the others is provided for each one of the tubular duct 17′, 17″, 17′″ for feeding a respective flow of solid materials therein.

With reference to the embodiment shown in FIGS. 1 to 6, there are two tubular ducts 17′, 17″ each one of which consists of one respective sector of a hollow cylindrical body 26 arranged inside the housing 11 and coaxial to o the central longitudinal axis A, wherein each one of such sectors is delimited by a portion of the side wall of the hollow cylindrical body 26 and by the longitudinal dividing wall 27 internal to it. The dividing wall 27 is fixed to the inner side surface of the hollow cylindrical body 26 and is shaped to divide the internal volume thereof in two longitudinal chambers forming each one respective tubular duct 17′, 17″. The hollow cylindrical body 26 extends between a first end downstream of the first input mouths 172′, 172″ and a second end upstream of the outflow opening 15. The dividing wall 27 is prolonged outside the first end of the hollow cylindrical body 26, joining with the bottom wall 16, and ends upstream of the second end of the hollow cylindrical body 26, the output mouths 173′, 173″ are spaced apart from the outflow opening 15 by a non-zero distance H, but, as described above, such distance H could be zero.

The first input mouths 172′, 172″ are formed in the first end tubular body 12a, which is jointed to the hollow cylindrical body 26. The second input mouths 174′, 174″ with the respective connecting fittings 20′, 20″ are on the bottom wall 16.

There is a containing gap 21 delimited by a pair of first tubular walls, which respectively consist of the outer side wall of the hollow cylindrical body 26 and of the inner side wall of a further hollow cylindrical body 31 arranged inside the housing 11 coaxially to the central longitudinal axis A and outside the hollow cylindrical body 26. The further hollow cylindrical body 31 is jointed at one end to the feeding manifold 22 of the containing gaseous fluid and at the opposite end to the third tubular body 14. The feeding manifold 22 consists of an annular chamber. In the depicted form, such annular chamber is delimited by the hollow cylindrical body 26 and by the first middle tubular body 12b at which the connecting fitting 220 is formed.

The containing gas flow, after travelling the containing gap 21, leads through the output opening 211 towards the inside of the furnace, facilitating and improving the transport of the solid materials injected towards the metal bath.

There is a cooling gap 23 which externally surrounds the containing gap 21. The cooling gap 23 is delimited by a pair of second tubular walls, which respectively consist of the outer side wall of the further hollow cylindrical body 31 and of the inner side wall of the second tubular body 13. The cooling gap 23 is closed at the third tubular body 14 which forms the outflow segment SE and is internally divided by a tubular dividing wall 32 in a cooling circuit. The cooling circuit has an outward duct and a return duct travelled by the cooling fluid and which, at the end facing the proximal end 111, are communicating with each other and which at the opposite end respectively end in the input opening 230 and in the output opening 231 of the cooling fluid flow.

The input opening 230 and the output opening 231 of the cooling fluid flow are longitudinally offset from each other and are in fluid communication respectively with the input manifold 24 and with the output manifold 25. The latter consist each of an annular chamber which is formed in the first middle tubular body 12b and in the first junction tubular body 12c, following one another, and are provided with a respective connecting fitting 240, 250 for entering and exiting the cooling fluid.

The embodiment shown in FIG. 7, which shows a cross section taken at the transporting segment ST, differs from that of FIGS. 1 to 6 due to the fact that the dividing wall 27′ has three radial planes which divide the volume internal to the hollow cylindrical body 26 in three sectors which, in cross section, have the shape of a circle sector and which form three tubular ducts 17′, 17″, 17″. For the rest, elements corresponding to those already described with reference to FIGS. 1-6 are indicated by the same reference number. The dividing wall 27′ is shaped so as to create inside the cavity internal to the lance 10 three distinct chambers 17′, 17″, 17′″ each defining one respective tubular duct. The dividing wall 27′ can be made in a single piece or alternatively by a plurality of pieces separated from each other, joined as long as the fluid separation between the three tubular ducts 17′, 17″, 17′″ is ensured. In this embodiment, the feeding manifolds of the flows of solid materials and the respective connecting fittings to the sources of solid materials are made similarly to what is described for the form shown in FIGS. 1-6. There will be three feeding manifolds each provided with one respective connecting fitting to one respective source of a flow of solid materials, arranged so as to serve each one respective tubular duct 17′, 17″, 17′″. Similarly, each tubular duct 17′, 17″, 17′″ can be provided with one respective connecting fitting for feeding one respective auxiliary gaseous flow therein. The embodiment shown in FIG. 8, which shows a cross section taken at the transporting segment ST, differs from that of FIGS. 1 to 6 due to the fact that each one of the tubular ducts 17′, 17″, 17′″ consists of a respective longitudinal hole formed in solid cylindrical body 28. Even in this case, elements corresponding to those already described with reference to FIGS. 1-6 are indicated by the same reference number. In this case, the containing gap 21 is delimited by a pair of first tubular walls, which respectively consist of the outer side wall of the solid cylindrical body 28 and of the inner side wall of a further hollow cylindrical body 31 similar to that described above.

The embodiment shown in FIG. 9A, which shows a cross section taken at the transporting segment ST, differs from that of FIG. 8 due to the fact that each one of the tubular ducts 17′, 17″, 17′″ consists of one respective hollow cylindrical body 29′, 29″, 29′″ which are housed in a further outer hollow cylindrical body 30. In this case, the containing gap 21 is delimited by a pair of first tubular walls, which respectively consist of the outer side wall of the outer cylindrical body 30 and of the inner side wall of a further hollow cylindrical body 31 similar to that described above.

The embodiment shown in FIG. 9 differs from that of FIG. 9A due to the fact that the hollow cylindrical body 30 is absent, in such case the containing gap 21 is delimited by the outer side surfaces of the hollow cylindrical bodies 29′, 29″, 29′″ and by the inner side wall of a further hollow cylindrical body 31 similar to that described above.

In all the alternative embodiments described above, there is a number of feeding manifolds of a respective flow of solid materials equal to the number of tubular ducts 17′, 17″, 17′″ each provided with a respective connecting fitting to a respective source of a flow of solid materials, arranged so as to serve each a respective tubular duct 17′, 17″, 17′″. Similarly, each tubular duct 17′, 17″, 17′″ can be provided with a respective connecting fitting for feeding a respective auxiliary gaseous flow therein.

It should be noted that the arrangement of the tubular ducts 17′, 17″ with longitudinal development axes B′, B″ parallel to each other and non-coincident and parallel to the central longitudinal axis A allows to locate all the respective first input mouths 172′, 172″ at the same level, i.e., at the same cross section of the lance 10. Thereby, the respective feeding manifolds 18′, 18″ with the respective connecting junctions 19′, 19″ can also be arranged at the same level, i.e., at the same cross section of the lance 10 and be made at the same longitudinal segment of the housing 11, without needing to offset them from each other, which allows to reduce the longitudinal bulk of the lance 10.

The tubular ducts 17′, 17″ or at least their inner walls can consist of different (metal or ceramic) materials or treated with surface coatings suitable to reduce the tendency to abrasion or corrosion in conjunction with the physical-chemical features of the injected solid materials; the same inner walls or the tubes can be made in longitudinal segments, even of materials different from each other. For example, using surface finishings or surface materials for each single tubular duct 17′, 17″ can be provided, depending on the solid material which needs to cross it as a function of the chemical-physical features (e.g., abrasiveness) of the latter.

Injecting the flows of solid materials can occur in sub-sonic, sonic, or super-sonic conditions. For the flows of solid materials injected in sonic or super-sonic conditions, the respective tubular ducts 17′, 17″ are provided in proximity to the respective output mouth 173′, 173″ with a convergent-divergent tract (De Laval nozzle).

Another object of the present invention is a granules and/or powder solid materials injection system 400 (FIG. 10) for injecting solid materials in the form of granules and/or powders into a metallurgical furnace 500 comprising a lance 10 as described above and at least one source S1, S2 . . . Sn for feeding a flow of solid materials in the form of granules and/or powders connected to said connecting junctions.

Advantageously, such a system 400 comprises for each one of the tubular ducts 17′, 17″ one respective feeding source S1, S2 . . . Sn of one respective flow of solid materials in the form of granules and/or powders connected to the respective said connecting junction, wherein the feeding sources S1, S2 . . . Sn differ from each other in the fed solid material in the form of granules and/or powders and/or in the transporting fluid.

Then, as shown in FIGS. 10-12, the system 400 comprises at least one feeding source G, G1, G2 . . . Gn of an auxiliary gaseous flow connected to the connecting fittings 20′, 20″ to the second input mouth 174′, 174″ of the tubular ducts 17′, 17″ for feeding an auxiliary gaseous flow for accelerating the respective flows of solid material therein.

The auxiliary gaseous flow assists in aligning the flow of solid material to the axial development of the respective tubular duct 17′, 17″ and to accelerate it towards the respective output mouth 173′, 173″. This allows to reduce the wear of the walls of the tubular ducts 17′, 17″ in particular at the respective first input mouth 172′, 172″ and, even in more particular, in the case where the latter develop along a direction C′, C″ incident to the longitudinal development axis B′, B″ of the respective tubular duct 17′, 17″.

As mentioned above, each flow of solid materials consists of solid materials in the form of granules and/or powders and of a carrier or transporting fluid, generally a carrier gas such as for example air, oxygen, or inert gases such as nitrogen or argon.

The flows of solid materials fed in the different tubular ducts 17′, 17″ can differ from each other for example in the typology of solid material and/or in the typology of transporting fluid and/or in the features of the feeding flow (flow rate, speed, temperature, pressure, etc.). In the latter regard, the system 400 comprises valves, pressure regulators, flow rate regulators, flow rate meters, pressure meters, and any other device required to carry out the desired adjustments known di per se and thereby not described in detail.

In the embodiment exemplified in FIG. 10 for each tubular duct 17′, 17″ a respective source S1, S2 of flow of solid materials, which feeds both the solid material and the carrier fluid therein, and a respective source G1, G2 of an auxiliary gaseous flow are provided.

The embodiment exemplified in FIG. 11 differs from the preceding one due to the fact that a single source G of an auxiliary gas is provided from which different ducts are derived for connecting with the connecting fittings 20′, 20″ of the tubular ducts 17′, 17″ (one connecting duct for each of the tubular ducts 17′, 17″) along which adjusting valves 402′, 402″0 and pressure meters 403′, 403″ are provided. Still in such case, the auxiliary gaseous flows fed in each tubular duct 17′, 17″ are separated from each other. Then, adjusting valves 401′, 401″ of the flows of solid materials separately feeding in each tubular duct 17′, 17″ are schematized.

The embodiment shown in FIG. 12 differs from that of FIG. 11 due to the fact that different ducts are also derived from the same source G of auxiliary gas for connecting with the connecting junctions 19′, 19″ of the tubular ducts 17′, 17″ (one connecting duct for each of the tubular ducts 17′, 17″) along which adjusting valves 404′, 404″ and pressure meters 405′, 405″ are provided. In such case, the same gas is used both as a carrier or transporting fluid for forming the flows of solid materials and as an auxiliary gaseous fluid for forming the auxiliary gaseous flows. The sources S1, S2 feed the respective solid material in the corresponding connecting duct with interposition of respective adjusting valves 406′, 406″.

Then, such a system can comprise a process gas (for example oxygen) injector 300 at supersonic speeds coupled to the lance 10.

Another object of the present invention is a metallurgical furnace 500, for example EAF, provided with a lance 10 or an injection system 400 as claimed and described.

As apparently shown in FIGS. 10-12, the furnace 500 comprises a lance 10 mounted in an opening formed in the walls thereof with the distal end 110 arranged outside it and with the proximal end 111 arranged inside it in proximity to the metal bath contained therein.

Another object of the present invention is a process for producing steel conducted in an electric arc furnace 500 as described above wherein it is provided injecting into the metal bath contained in the furnace 500, simultaneously or in deferred times, at least two flows of solid materials different from each other through the same lance 10, each flow of solid material being fed separately from the other in a respective tubular duct 17′, 17″ of said same lance 10.

Advantageously, it is provided feeding into at least one of the tubular ducts 17′, 17″ a respective auxiliary gaseous flow for accelerating the respective flow of solid materials.

The injection lance object of the present invention has the advantage, with the same typologies of solid materials to be injected in a furnace, of decreasing the number of openings to be formed in the walls of the furnace and the number of cooled supports for supporting and cooling the lances, resulting in advantages in terms of reduction of the thermal losses towards the environment, and therefore a greater overall efficiency of the plant.

The lance according to the invention further allows to generally reduce the number of operating devices, since each single lance allows to manage a plurality of solid materials, resulting in lower maintenance and management costs.

Furthermore, a lance according to the invention allows simplifying the modernization (upgrade) of an existing furnace for injecting new and/or different solid materials therein. For example, an existing furnace, provided with injectors for coal, can be also equipped for injecting polymeric materials, incompatible—in chemical-physical features—with the injectors optimized for the coal: for this purpose, it is sufficient to replace the operating injectors with lances according to the invention, without modifying the structure the furnace, in particular without making additional openings, resulting in decreased investment costs for the upgrade.

Then, the lance according to the invention allows to increase the injection efficiency, due to the optimal positioning of a single lance for injecting solid materials according to the invention coupling with a supersonic oxygen jet, which allows to use such supersonic flow for multiple solid materials, instead of having multiple lances for injecting solid materials in proximity to one single oxygen lance, resulting in sub-optimal positioning. Thereby, the penetration of the solid materials injected into the slag layer can be optimized, simultaneously minimizing the risk of dragging by the fluid currents towards the flue gases sucking plant.

Then, with the lance according to the invention an overall increase of the process efficiency and flexibility can be obtained: having a plurality of flows of optimized solid materials for each single typology of solid material to be injected, also with an optimized positioning with a possible supersonic oxygen injector, advanced configurations for controlling the temperature and optimization of the “foaming” of the slag can be managed. For example, switching from injecting low volatility solid materials (e.g., coal) to injecting high volatility solid materials (e.g., plastics, rubbers, biochar) can be made, due to the possibility of injecting simultaneously and in the same flow materials suitable to control possible temperature hot spots which could be formed due to the high volatility resulting in an excessive local fluidification of the slag.

Furthermore, with respect to the solution known from U.S. Pat. No. 6,558,614, the lance according to the invention has a greater compactness, due to the making of the tubular ducts 17′, 17″ placed side by side and parallel to each other rather than concentric, which allows to place the feeding manifolds and the respective connecting junctions side by side to the corresponding feeding sources and therefore to decrease the longitudinal bulk.

Furthermore, if required, an optimized and uniform passage section for all the flows of solid materials can be ensured, differently from the solution of the state of the art with concentric passages wherein—with the same section—the passage thickness decreases with the distance from the axis of the lance. Finally, keeping the lance for injecting solid materials separated from that for injecting a gas (oxygen) supersonic jet, the distance between centres and the inclination between the directions of the oxygen supersonic jet and of the jets of solid material can be varied, thus obtaining a greater injection flexibility and a better injection distribution on the bath.

The injecting lance thus conceived is susceptible of a number of modifications and variants, all falling within the invention; furthermore, all the details are replaceable by technically equivalent elements. In practice, the used materials, as well as the size, can be any depending on the technical requirements.

1. A granule or powder solid materials injection lance for injecting solid materials in the form of granules or powders into a metallurgical furnace comprising:
a tubular housing having a central longitudinal axis and extending between a distal end and a proximal end axially opposite to each other and along which, starting from said distal end, a plurality of longitudinal segments follow one another: a feeding segment of solid materials in the form of granules or powders, a transporting segment of the fed solid materials and an outflow segment of the transported solid materials comprising an outflow opening at said proximal end;
a plurality of distinct tubular ducts, arranged inside said housing, wherein each of said tubular ducts, has a longitudinal development axis and extends longitudinally between a first end, and a second end along at least one portion of said feeding segment, at which it has at least one first input mouth of a respective flow of solid materials in the form of granules or powders, and along at least one portion of said transporting segment ending in a output mouth of said respective flow of solid materials which is in fluid communication with said outflow opening, wherein the longitudinal development axes of said tubular ducts are non-coincident with each other and are parallel to said central longitudinal axis; and
at least one feeding manifold for each one of said tubular ducts, wherein said at least one feeding manifold is associated with said housing at said feeding segment and is in fluid communication with said at least one first input mouth of the respective said tubular duct and is provided with at least one connecting junction couplable to a feeding source of said respective flow of solid materials.

2. The lance according to claim 1, wherein said first input mouth is formed at the side wall which delimits the respective tubular duct and develops along a direction incident to the longitudinal development axis of the respective tubular duct forming a non-zero angle with it or wherein said first input mouth is formed at said first end of the respective tubular duct and develops along a direction parallel or coincident with the longitudinal development axis of the respective tubular duct.

3. The lance according to claim 1, characterized in that at least one of said tubular ducts comprises at least one second input mouth of an auxiliary gaseous flow, wherein said second input mouth is defined along the longitudinal portion of said tubular duct extending along said feeding segment and which is in fluid communication with a respective connecting fitting couplable to a feeding source of an auxiliary gaseous flow.

4. The lance according to claim 3, wherein said second input mouth is formed at said first end of said tubular duct and develops along a direction parallel or coincident with the longitudinal development axis of the respective tubular duct or wherein said second input mouth is formed at the side wall which delimits the respective tubular duct and develops along a direction incident to the longitudinal development axis of the respective tubular duct forming a non-zero angle with it.

5. The lance according to claim 1, characterized in that between said output mouth of each of said tubular ducts and said outflow opening there is a distance H between 0% and 90% of the overall length of at least said transporting segment and said outflow segment.

6. The lance according to claim 1, characterized by comprising:
at least one containing gap adapted to be crossed by a containing gaseous flow, longitudinally extending along at least one portion of said feeding segment, at which it has at least one input opening of a containing gaseous flow, and along at least one portion of said transporting segment ending in an output opening of said containing gaseous flow which is in fluid communication with said outflow opening, wherein said containing gap externally surrounds said tubular ducts, and
at least one feeding manifold associated with said housing at said feeding segment and in fluid communication with said at least one input opening of said containing gap and provided with at least one respective connecting fitting couplable to a feeding source of said respective containing gaseous flow.

7. The lance according to claim 1, characterized by comprising:
at least one cooling gap which forms or houses a cooling circuit and longitudinally extending along at least one portion of said feeding segment, at which said cooling circuit has at least one input opening and at least one output opening of a cooling fluid flow, and along at least one portion of said transporting segment, wherein said cooling gap externally surrounds the assembly of said tubular ducts, and
at least one input manifold and at least one output manifold associated with said housing at said feeding segment and in fluid communication respectively with said at least one input opening and with said at least one output opening of said cooling circuit and each of which is provided with at least one respective connecting fitting respectively couplable to a feeding source of said cooling fluid and to a discharge of said cooling fluid.

8. The lance according to claim 1, characterized in that each of said tubular ducts consists of a respective sector of a hollow cylindrical body arranged inside said housing and coaxial to said central longitudinal axis, each of said sectors being delimited by a portion of the side wall of said hollow cylindrical body and by at least one longitudinal dividing wall extending inside said hollow cylindrical body.

9. The lance according to of claim 1, characterized in that each of said tubular ducts consists of a respective hollow cylindrical body.

10. The lance according to claim 1, characterized in that each of said tubular ducts consists of a respective longitudinal hole formed in a solid cylindrical body.

11. A granule or powder solid materials injection system for injecting solid materials in the form of granules or powders into a metallurgical furnace comprising a lance according to claim 1 and at least one feeding source of a flow of solid materials in the form of granules or powders connected to said connecting junctions.

12. The system according to claim 11, characterized by comprising for each one of said tubular ducts a respective feeding source of a respective flow of solid materials in the form of granules or powders connected to the respective said connecting junction, wherein each flow of solid materials comprises solid materials in the form of granules or powders and a transporting fluid and wherein said feeding sources differ from each other in the fed solid material in the form of granules or powders or in the transporting fluid.

13. The system according to claim 12, comprising a process gas injector at supersonic speeds coupled to said lance.

14. The system according to claim 11, characterized by comprising at least one feeding source of an auxiliary gaseous flow connected to the connecting fittings to the second input mouth of said tubular ducts for feeding an auxiliary gaseous flow for accelerating the respective flows of solid material therein.

15. An electric arc furnace for conducting processes for producing steel comprising at least one lance according to claim 1 whose distal end is arranged outside it and whose proximal end is arranged inside it in proximity to the metal bath contained therein.

16. A process for producing steel conducted in an electric arc furnace according to claim 15 comprising injecting into the metal bath contained in said electric arc furnace at least two flows of solid materials different from each other through one and the same said lance, each flow of solid material being fed separately from the other in one respective tubular duct of said same lance.

17. The process for producing steel according to claim 16, comprising feeding in at least one of said tubular ducts a respective auxiliary gaseous flow for accelerating the respective flow of solid materials.
